(19) United States
(12) Patent Application Publication
(10) Pub. No.: US 2010/0288424 A1
(43) Pub. Date: Nov. 18, 2010

(54) METHOD FOR MANUFACTURING PNEUMATIC TIRE

(75) Inventor: Kenichi Yamashita, (US)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/671,230

(22) PCT Filed: Apr. 22, 2008
(86) PCT No.: PCT/JP2008/057721

§ 371 Date: Jan. 29, 2010

(30) Foreign Application Priority Data
Aug. 9, 2007 (JP) 2007-207852

(51) Int. Cl. B29D 30/32

(52) U.S. Cl. 156/131

(57) ABSTRACT

The present invention is to provide a method for manufacturing a pneumatic tire with reduced dynamic unbalance and enhanced durability. The method for manufacturing a pneumatic tire having projections in a buttress portion comprises the steps of laminating a sidewall rubber 17 on the outer side of a carcass ply 12 and expanding the diameter of a shaping drum 1, followed by laminating a belt layer 19 and a tread rubber 18 on the outer side of the position corresponding to a crown portion of the carcass ply 12 to mold a green tire G, laminating a strip-shaped rubber member 21 to a buttress portion B of the green tire G to form annular projection parts 22, and vulcanization molding the green tire G with a mold.

### TECHNICAL FIELD

The present invention relates to a method for manufacturing a pneumatic tire designed for driving on rough roads such as a muddy road, a gravel road, a dirt road and the like, and in more detail, it relates to a method for manufacturing a pneumatic tire having projections in a buttress portion contacted to the ground at the time of driving on rough roads and improving performance on rough roads.

The description of this application claims benefit of priority based on Japanese Patent Application No. 2007-207852 filed on Aug. 9, 2007, the entire same contents of which are incorporated by reference herein.

### BACKGROUND ART

A pneumatic tire designed for driving on rough roads has projections formed in a buttress portion which is not grounded when driving on a flat road. When driving on a rough road with uneven, but not flat, surface, the projections come into contact with the road surface, thereby improving the driving performance and braking performance on rough roads.

On the other hand, Patent Document 1 discloses a method for manufacturing a pneumatic tire with a projection formed on a portion of a sidewall near to a bead. This projection is called a rim protect bar. In this manufacturing method, a belt-shaped rubber with the projection formed is wound around a green tire that is stuck onto a shaping drum before expanding the diameter of the green tire.

Patent document 1: Unexamined Japanese Laid-Open Patent Publication No. 2006-305891, (FIG. 1)

### DISCLOSURE OF THE INVENTION

### Problem to be Solved by the Invention

When a pneumatic tire having projections in a buttress portion is manufactured by the manufacturing method of Patent Document 1, the thickness of rubber in the buttress portion is not uniform, resulting in the generation of a thin part of the rubber. This is because the diameter expansion ratio of the buttress portion is larger than that in the vicinity of the bead when expanding the diameter of the green tire.

In cases where the rubber has some parts having thinner thickness in the buttress portion, it causes dynamic unbalance, resulting in the deterioration of tire performance. Furthermore, since high-density parts and low-density parts in cord of a carcass ply are produced, there is a problem of deteriorating tire durability.

The object of the present invention is to provide a method for manufacturing a pneumatic tire with reduced dynamic unbalance and enhanced durability.

### Means for Solving the Problems

The method for manufacturing a pneumatic tire of the present invention is for manufacturing a pneumatic tire having projections in a buttress portion, comprising the steps of:

laminating an inner liner on a shaping drum, laminating a carcass ply on the outer side of the inner liner, mounting a pair of beads having a bead core and a bead filler on both ends of the carcass ply and folding the both ends of the carcass ply so that an end portion of the carcass ply rolls up each bead;

laminating a sidewall rubber on the outer side of the carcass ply;

expanding the diameter of the shaping drum, followed by laminating a belt layer and a tread rubber on the outer side of the position corresponding to a crown portion of the carcass ply to mold a green tire;

laminating a strip-shaped rubber member to the buttress portion of the green tire to form annular projection parts; and

vulcanization molding the green tire with a mold.

The method for manufacturing a pneumatic tire of the present invention is for manufacturing a pneumatic tire having projections in a buttress portion, comprising the steps of:

laminating an inner liner on a shaping drum, laminating a carcass ply on the outer side of the inner liner, mounting a pair of beads having a bead core and a bead filler on both ends of the carcass ply and folding the both ends of the carcass ply so that an end portion of the carcass ply rolls up each bead;

laminating a sidewall rubber on the outer side of the carcass ply;

expanding the diameter of the shaping drum, followed by laminating a belt layer and a tread rubber on the outer side of the position corresponding to a crown portion of the carcass ply to mold a green tire;

winding a ribbon-like rubber member around the buttress portion of the green tire multiple times to form annular projection parts; and

vulcanization molding the green tire with a mold.

In the manufacturing method of the present invention, the annular projection parts can be formed without change in thickness due to forming of the annular projection parts in the buttress portion after expanding the diameter of the green tire. As a result, dynamic unbalance can be reduced in the molded tire. Without developing any higher and lower portions in cord density of the carcass ply, durability of the tire is not degraded. Furthermore, driving performance and braking performance on rough roads can be improved by projections molded in the buttress portion to be molded.

### BRIEF DESCRIPTION OF THE DRAWINGS

FIG. 1 is a view showing each step of the method for manufacturing a pneumatic tire according to the present invention.

FIG. 2 is a view showing an aspect of forming annular projection parts in a green tire.

FIG. 3 is a view showing a pneumatic tire with annular projection parts formed.

FIG. 4 is a view showing a pneumatic tire with annular projection parts formed.

FIG. 5 is a view showing projections of the tire in Examples and Comparative Examples.

### DESCRIPTION OF THE REFERENCE NUMERALS

1 shaping drum
11 inner liner
12 carcass ply
13 bead core
14 bead filler
15 bead
17 sidewall rubber
18 tread rubber
19 belt layer
30 projections

### BEST MODE FOR CARRYING OUT THE INVENTION

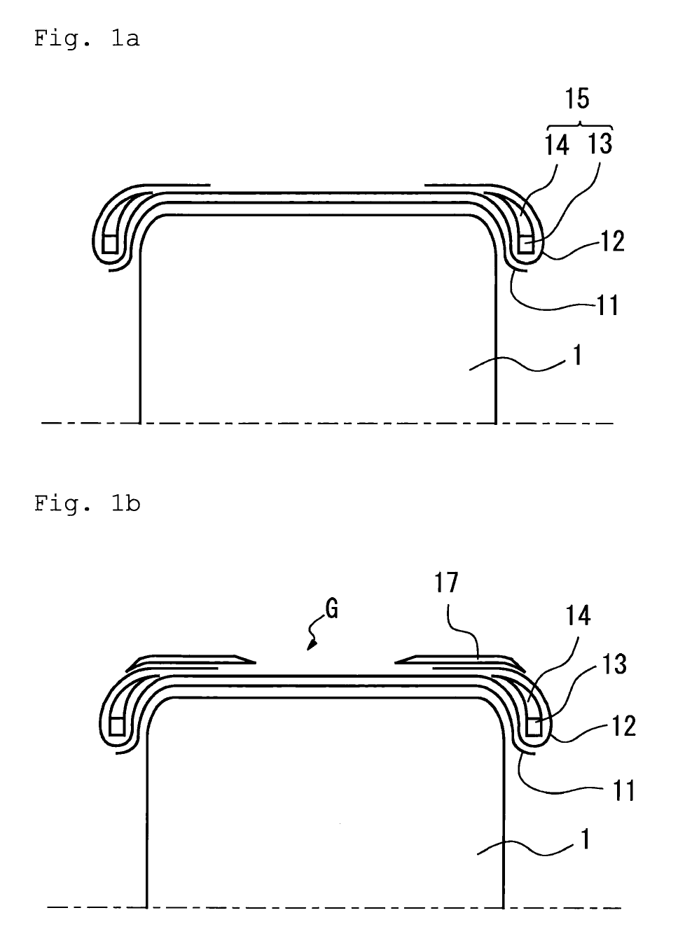

Hereinafter, embodiments of the method for manufacturing a pneumatic tire according to the present invention will be described with referent to the drawings. First of all, in FIG. 1(a), an inner liner 11 and a carcass ply 12 are laminated on the cylindrical side surface of a shaping drum 1. On both ends of the carcass ply 12, a pair of beads 15 comprising a bead core 13 and a bead filler 14 are arranged, and the ends of the carcass ply 12 are folded so as to roll up the beads 15. Lamination of the inner liner 11 and the carcass ply 12 onto a shaping drum 1 and rolling up of the beads 15 can be conducted by the known manufacturing method. Next, the green tire G before diameter expansion is completed by laminating a sidewall rubber 17 as shown in FIG. 1(b). Number of the carcass ply 12 may be increased as needed. Further, other required members may be laminated before diameter expansion.

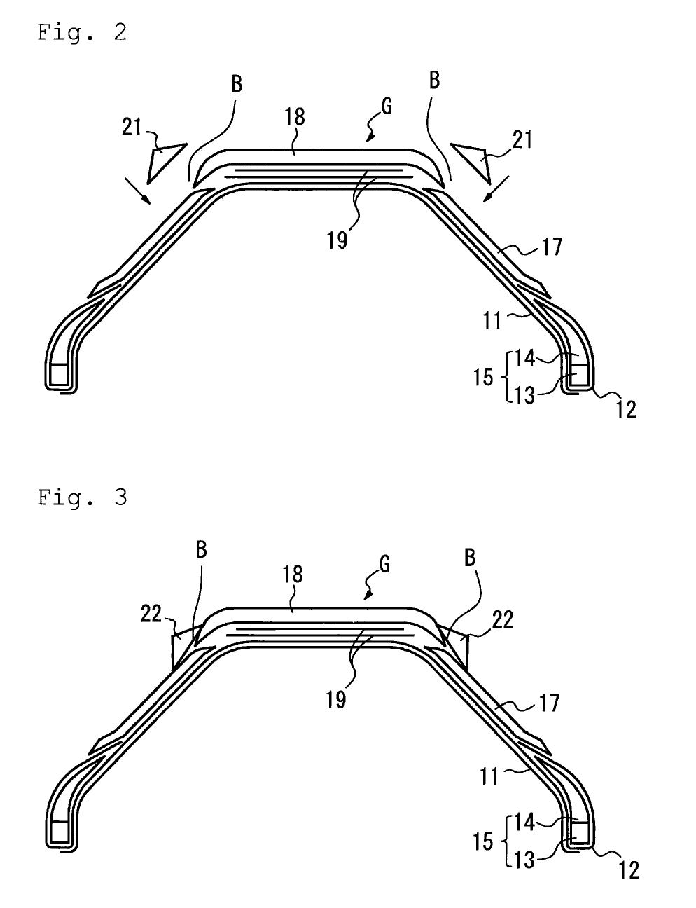

FIG. 2 is a cross-sectional view showing the green tire G whose diameter is expanded. The diameter expansion is carried out in the known expanding drum (not illustrated). A belt layer 19 and a tread rubber 18 are laminated on the outer side of the position corresponding to a crown portion of the carcass ply 12 of the expanded green tire G, followed by laminating a strip-shaped rubber member 21 having a triangular cross section to a buttress portion B of the green tire G in the circumferential direction. Therefore, as shown in FIG. 3, the green tire G after the strip-shaped rubber member 21 is laminated thereto includes annular projection parts 22 formed in the buttress portion. Then, the green tire G is vulcanization molded by a mold (not illustrated). At this time, by providing a concave portion having a given shape on the molded surface of the mold to mold the buttress portion, projections having a desired shape are formed in the buttress portion of the green tire G. The cross sectional shape of the strip-shaped member 21 can be appropriately changed by the shape of the projections in the buttress portion to be molded. Furthermore, number of the belt layer 19 may be increased as need.

Since the annular projection parts 22 are formed in the buttress portion after the diameter of the green tire G is expanded, the annular projection parts 22 can be formed without change in thickness. As a result, dynamic unbalance can be reduced in the molded tire. Without developing any high-density parts and low-density parts in cord of the carcass ply 12, the durability of the tire can not be degraded. In addition, by the projections molded in the buttress portion to be molded, driving performance and braking performance on rough roads can be improved.

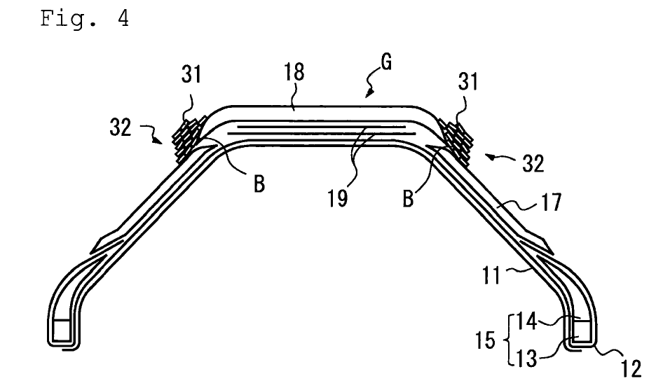

FIG. 4 is a cross-sectional view showing the green tire G whose diameter is expanded. With a ribbon-shaped rubber member 31 wound multiple times around the buttress portion of the green tire G whose diameter is expanded, annular projection parts 32 are formed. After that, as heretofore, the green tire G is vulcanization molded by a mold (not illustrated) and projections having desired shapes are formed in the buttress portion.

Since diameters are different between the outer side and inner side in the radial direction of the buttress portion where projections are to be formed, in case of laminating the strip-shaped member 21, wrinkles are likely to be generated at an edge part of the strip-shaped member 21, and air may be entered or the flow of the rubber may be impaired. However, by winding the ribbon-shaped rubber member 31, the annular projection parts 32 can be formed without developing any wrinkles. Furthermore, the dimension of the ribbon-shaped rubber member 31 is not specifically limited, but a width of 15 mm to 35 mm and a thickness of 1.0 mm to 3.0 mm are preferable.

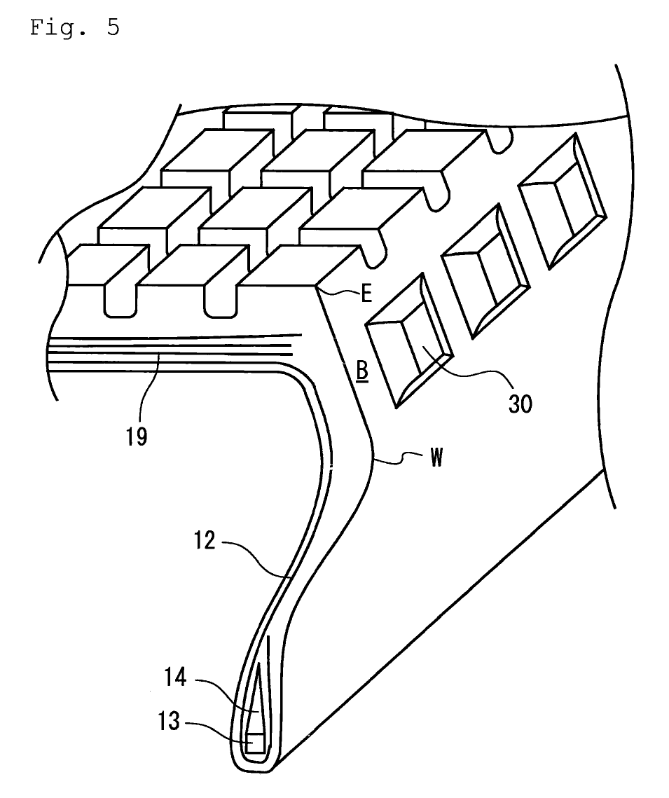

The buttress portion in the present application means the range from a grounding end E in the tread width direction toward the inner side in the tire radial direction to a position W, which is the maximum width in the tire cross section, as shown in FIG. 5. Also, the projections of the buttress portion are to include projections arranged at intervals as well as projections arranged annularly.

### Example

As a practical example of the tire, a pneumatic tire having projections in a buttress portion was prepared by the manufacturing method according to the present invention and evaluated. Example 1 shows the tire obtained by expanding the diameter of a green tire, followed by laminating a strip-shaped rubber member (whose cross-section is in a trapezoidal shape having the width on the upper side of 35 mm, the width on the lower side of 100 mm and the height of 9 mm) to a buttress portion to form annular projection parts, and then vulcanization molding Example 2 shows the tire obtained by expanding the diameter of a green tire, followed by winding a ribbon-shaped rubber member (which is 25 mm wide and 1.5 mm thick) in the buttress portion 16 times to form annular projection parts, and then vulcanization molding. Comparative Example 1 shows the tire having no projections in a buttress portion and Comparative Example 2 shows the tire having the same projections as the tires of Examples 1 and 2, which is obtained by laminating a strip-shaped rubber member (whose cross-section is in a trapezoidal shape having the width on the upper side of 35 mm, the width on the lower side of 100 mm and the height of 13 mm) to the position corresponding to the buttress portion before expanding the diameter of a green tire (in a state corresponding to FIG. 1(b)), followed by expanding the diameter of the green tire and vulcanization molding. Comparative Example 3 shows the tire having the same projections as the tires of Examples 1 and 2, which is obtained by winding a ribbon-shaped rubber member (which is the same as Example 2) at the position corresponding to the buttress portion before expanding the diameter of a green tire (in a state corresponding to FIG. 1(b)) 25 times, followed by expanding the diameter of the green tire and vulcanization molding.

In order to make volumes substantially equal between the rubber members which form annular projection parts, the height of the strip-shaped rubber member or the number of turns of winding the ribbon-shaped rubber member is varied between the case that the rubber member is laminated or wound before diameter expansion and the case that the rubber member is laminated or wound after diameter expansion.

As shown in FIG. 5, projections 30 formed in the buttress portion B, which have the width in the circumferential direction of 110 mm, the width in the radial direction of 50 mm and the projection height of 10 mm, are arranged annularly in the tire circumferential direction at 30 mm intervals. For the strip-shaped rubber member and ribbon-shaped rubber member, rubbers having the same composition as sidewall rubbers were used. Any tire sizes were LT 315/75R16.

Evaluation results are shown in Table 1. The traveling ability on rough road denotes time required for running through a 5-kilometer rough road with the tires installed on the pick-up truck (manufactured by Ford Motor Company, F150). The dynamic unbalance is the result from measurement of dynamic unbalance by a dynamic unbalance evaluating device (manufactured by Kokusai Keisokuki Kabushiki Kaisha, Type: Model FDB 6142). Any results are represented by indices defining the value obtained in Comparative Example 1 as 100, in which larger numbers indicate better evaluation results. The tires manufactured by the manufacturing method of the present application enable to maintain the traveling ability on rough road and reduce dynamic unbalance.

TABLE 1

| | | | Comparative | Comparative | Comparative |
|---|---|---|---|---|---|
| | Example 1 | Example 2 | Example 1 | Example 2 | Example 3 |
| traveling ability on | 102 | 102 | 100 | 102 | 102 |
| rough road | | | | | |
| Dynamic Unbalance | 105 | 108 | 100 | 95 | 97 |

What is claimed is:

1. A method for manufacturing a pneumatic tire having projections in a buttress portion, comprising the steps of:
laminating an inner liner on a shaping drum, laminating a carcass ply on the outer side of said inner liner, mounting a pair of beads having a bead core and a bead filler on both ends of said carcass ply and folding the both ends of said carcass ply so that an end portion of said carcass ply rolls up each bead;
laminating a sidewall rubber on the outer side of said carcass ply;
expanding the diameter of said shaping drum, followed by laminating a belt layer and a tread rubber on the outer side of the position corresponding to a crown portion of said carcass ply to mold a green tire;
laminating a strip-shaped rubber member to the buttress portion of said green tire to form annular projection parts; and
vulcanization molding said green tire with a mold.

2. A method for manufacturing a pneumatic tire having projections in a buttress portion, comprising the steps of:
laminating an inner liner on a shaping drum, laminating a carcass ply on the outer side of said inner liner, mounting a pair of beads having a bead core and a bead filler on both ends of said carcass ply and folding the both ends of said carcass ply so that an end portion of said carcass ply rolls up each bead;
laminating a sidewall rubber on the outer side of said carcass ply;
expanding the diameter of said shaping drum, followed by laminating a belt layer and a tread rubber on the outer side of the position corresponding to a crown portion of said carcass ply to mold a green tire;
winding a ribbon-like rubber member around the buttress portion of said green tire multiple times to form annular projection parts; and
vulcanization molding said green tire with a mold.
